(19) United States
(12) Patent Application Publication
(10) Pub. No.: US 2004/0005003 A1
(43) Pub. Date: Jan. 8, 2004

(54) Quality improvement for FGS BL coding with U/V coarse quantization

(75) Inventor: Shaomin Sharon Peng, Yorktown, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/188,138

(22) Filed: Jul. 2, 2002

(51) Int. Cl. H04N 7/12

(52) U.S. Cl. 375/240.03; 375/240.2

(57) ABSTRACT

A Fine Granular Scalability (FGS) encoding system and method having a base layer encoder and an enhancement layer encoder, wherein the base layer encoder comprises: a discrete cosine transform (DCT) system for generating a DCT signal having a Y component and a U/V component; and a quantizer system for separately quantizing the Y component and U/V component such that more bits can be assigned to the Y component than the U/V component.

### BACKGROUND OF THE INVENTION

1. Technical Field

The present invention relates generally to encoding systems, and more particularly to a system and method of Fine Granular Scalability (FGS) base layer (BL) coding in which the Y components are quantized separately from the U/V components to improve visual quality.

2. Related Art

Fine Granular Scalability (FGS) has been adopted by the MPEG-4 group as the international standard for scalable coding. FGS coding is particularly suitable for video streaming through bandwidth variant channels such as the Internet, intranets, home networks, wireless networks, cellular networks, etc. The FGS coding scheme dynamically codes a video sequence within a bandwidth range (e.g., R_{low}, R_{high}) by adjusting or scaling the video information. Specifically, FGS utilizes two bit-streams, a base layer (BL) bit-stream that is coded with a guaranteed bandwidth R_{low}, and an enhancement layer bit-stream (EL) that is coded in a scalable manner. Under FGS, the EL bit-stream is coded such that it can always be decoded even when truncated at any bandwidth level between R_{low} and R_{high}. For very low bit rate coding where little or no EL information is transmitted, the visual quality of the decoder output is heavily affected by the BL coding quality.

Both the BL and EL bit-streams comprise Y, U, and V components. The Y components generally represent texture of objects within a scene, while the U/V components represent color. The loss of texture information is generally much more sensitive to the human eye than color loss, which may for instance occur when observing decoded images subject to a limited bandwidth. Moreover, because U/V components are coded in a much better PSNR (peak signal-to-noise ratio) than the Y components, coding reductions associated with U/V components are relatively less degrading than reductions associated with Y components. In other words, in a low bandwidth scenario, losses associated with the Y components are more critical to the visual quality of the decoded image than the U/V components.

The standard method of coding BL and EL bit-streams is to code Y, U, and V components in the same manner, such that all of the components are coded in the BL with the same rate control scheme, and the residual of the BL from all three components are coded in the EL with bit-plane coding. Therefore, standard coding methods fail to address the importance of the Y components relative to the U/V components in delivering picture quality in low bandwidth situations, and consequently code U/V components in much better PNSR than Y components.

### SUMMARY OF THE INVENTION

The present invention addresses the above-mentioned problems, as well as others, by providing a system and method for quantizing Y components separately from the U/V components in a base layer (BL) encoder. In a first aspect, the invention provides a Fine Granular Scalability (FGS) encoding system having a base layer encoder and an enhancement layer encoder, wherein the base layer encoder comprises: a discrete cosine transform (DCT) system for generating a DCT signal having a Y component and a U/V component; and a quantizer system for separately quantizing the Y component and U/V component such that more bits can be assigned to the Y component than the U/V component.

In a second aspect, the invention provides a base layer encoding method for encoding a video signal using Fine Granular Scalability (FGS), comprising: inputting a video signal into a base layer (BL) encoder; performing a discrete cosine transform (DCT) operation to generate a DCT signal having a Y component and a U/V component; quantizing the Y component and U/V component separately such that more bits are assigned to the Y component than the U/V component.

In a third aspect, the invention provides a quantizer system for quantizing a discrete cosine transform (DCT) signal in a Fine Granular Scalability (FGS) base layer encoder, comprising: a first quantizer for quantizing a Y component of the DCT signal with a first quantization parameter; a second quantizer for separately quantizing a U/V component of the DCT signal with a second quantization parameter; and wherein the first quantization parameter is less than the second quantization parameter so that more bits are assigned to the Y component than the U/V component.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an FGS encoder in accordance with the present invention.

FIG. 2 depicts a quantizer system of the FGS encoder of FIG. 1 in accordance of the present invention.

### DETAILED DESCRIPTION OF THE INVENTION

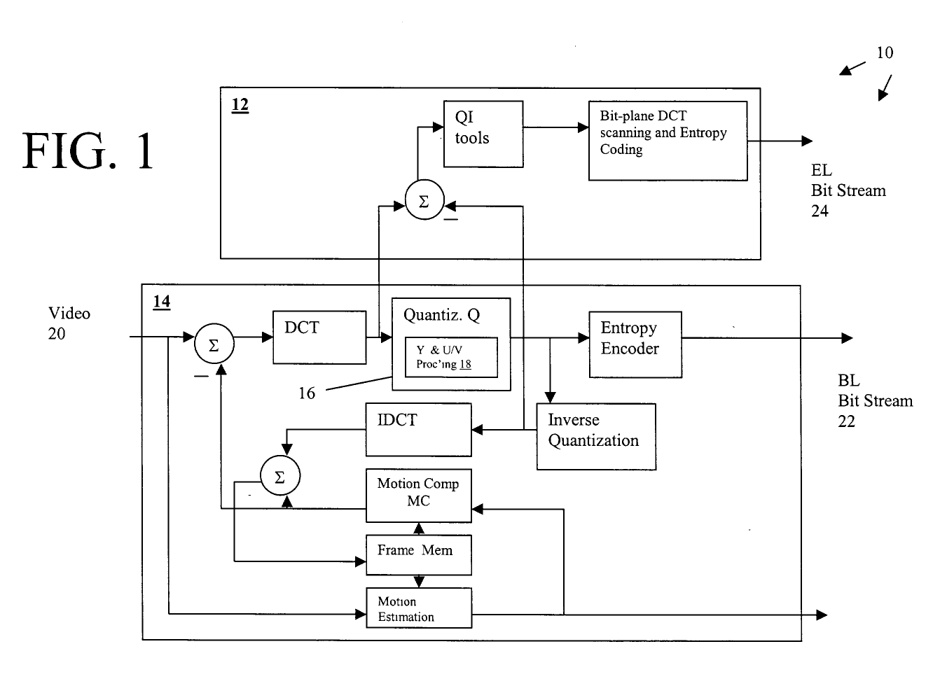

Referring now to the drawings, FIG. 1 depicts an FGS encoder 10 in accordance with the present invention. FGS encoder 10 includes a base layer encoder 14 and an enhancement layer encoder 12. Base layer encoder 14 receives a video input 20 and outputs a base layer (BL) bit stream 22. Enhancement layer encoder 12 receives quantization residuals from the base layer encoder and generates an enhancement layer (EL) bit stream 24. FGS encoder 10 represents a standard state-of-the-art encoder. It should be understood that while an MPEG-4 FGS encoding system is generally described herein, the present invention is applicable to any encoder that can separately process Y and U/V components, including H.26L, H.263, etc. In this case, quantizer 16 includes a Y & U/V processing system 18 that allows Y and U/V components to be separately quantized.

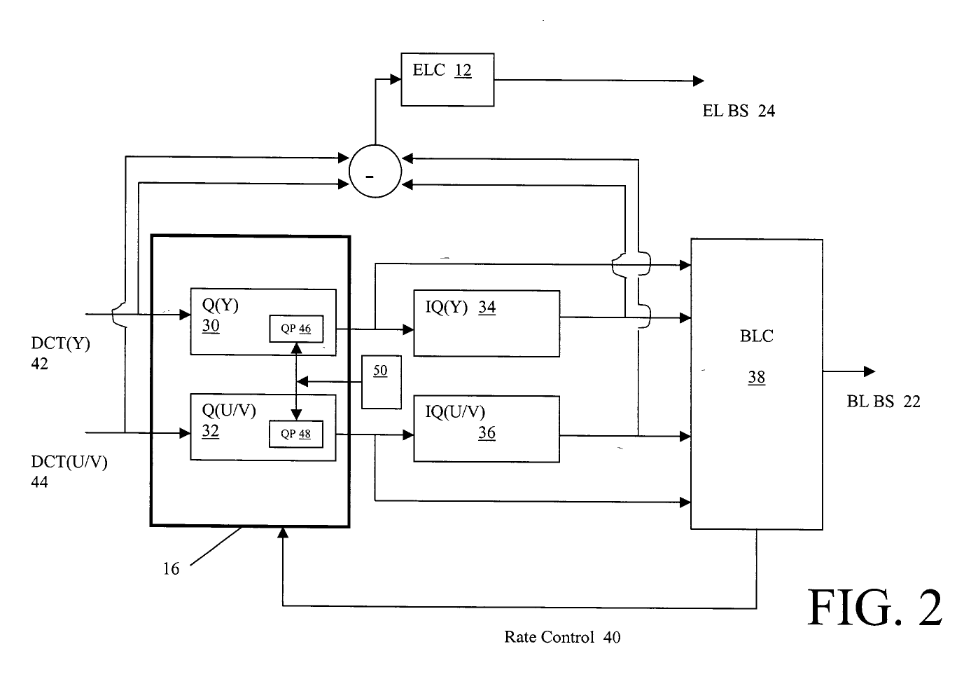

Y & U/V processing system 18 (which is described in more detail in FIG. 2 as QP 46, QP 48 and QP selection system 50) allows Y components to be coded with relatively more bits than U/V components. To achieve this, the Y components are assigned a smaller quantization parameter than the U/V components. In one exemplary embodiment, the U/V components are quantized to the upper limit (i.e., with the highest possible quantization parameter) so that the Y components are coded with the best possible quality at the base layer.

When the coding rate of the base layer (RBL) is very low, the output quality for the base layer will similarly be very low. As noted above, the resulting visual degradation will be particularly bad due to the loss of texture in the image objects. It has been found that coding the texture with relatively higher quality and little or no color is a more visually pleasing option. This is addressed by improving the Y component coding quality and reducing the coding quality of the U/V components at the base layer. Thus, rather than treating Y, U, and V equally in the base layer, the present invention sacrifices a certain number of bits for the U/V components in favor of the Y components. The result is an improved visual output under low bandwidth conditions, in which texture is favored over color with respect to base layer coding. When a higher bandwidth becomes available, the color residual, which can be coded by the EL, may be added on gradually.

Referring now to FIG. 2, an exemplary quantization system 16 is shown. Quantization system 16 receives an input DCT residual signal having a Y component DCT(Y) 42 and a U/V component DCT(U/V) 44. Quantization system 16 includes a first quantizer Q(Y) 30 for quantizing the Y component 42 and a second quantizer Q(U/V) 32 for quantizing the U/V component 44. The quantized signals are then passed to a first inverse quantizer IQ(Y) 34 that receives the output of Q(Y) 30 and a second inverse quantizer IQ(U/V) 36 that receives the output of Q(U/V) 32.

Both Q(Y) 30 and Q(UNV) 32 include a quantization parameter QP 46 and 48, respectively, which is the key parameter for rate control. The greater the value chosen for the quantization parameter, the more quantization will be applied to the respective component, and the fewer bits required to code the component. QP 46 and QP 48 are selected, for example, by QP selection system 50. It is understood that QP selection system 50 can select the quantization parameters within the standard constraint range in any manner. It is also understood that QP selection system 50 can reside as part of, or separately from, quantizer 16.

In one exemplary embodiment, QP selection system 50 can select the quantization parameters based on available number of bits relative to bit rate control. In this case, a base layer controller (BLC) 38 is utilized to provide a feedback signal, namely rate control signal 40, which communicates to quantizer 16 the available number of bits. Based on the available number of bits, QP selection system 50 can optimally select QP 46 and QP 48 for Q(Y) 30 and Q(U/V) 32, respectively. In this situation, a look-up table or algorithm may be utilized to determine how to select QP's 46 and 48, and therefore allocate bits between the Y and U/V components.

Moreover, QP 48 for Q(U/V) may be preset to a relatively large or even maximum value (e.g., QP=31) to achieve a coarse quantization, depending on how much tradeoff is desired. Then, QP 46 for Q(Y) can be selected by QP selection system 50 to a lowest possible value based on the available number of bits, as dictated by rate control signal 40. Thus, for example, by choosing the maximum value for QP 48, the Y component will always receive the highest possible number of bits in the base layer coding. Because the U/V quantization parameter 48 is set very high, fewer bits will be assigned to the UN components, and the saved bits can be used for the Y components, resulting in better base layer quality.

In an extreme case, the U/V components may be assumed to be quantized to 0 (i.e., U/V=0) at the base layer so that all assigned bits can be assigned to coding the Y components. In this case, the UN components should still be run length coded with 0 so that all of the values are coded at the enhancement layer.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A Fine Granular Scalability (FGS) encoding system having a base layer encoder and an enhancement layer encoder, wherein the base layer encoder comprises:
a discrete cosine transform (DCT) system for generating a DCT signal having a Y component and a U/V component; and
a quantizer system for separately quantizing the Y component and U/V component such that more bits can be assigned to the Y component than the U/V component.

2. The FGS encoding system of claim 1, wherein a coarser quantization parameter is used for the U/V component than the Y component.

3. The FGS encoding system of claim 1, wherein the quantization parameter associated with the U/V component is preset to a maximum value.

4. The FGS encoding system of claim 1, wherein quantization parameters associated with the Y component and U/V component are varied based on a feedback signal from a base layer rate controller.

5. The FGS encoding system of claim 4, wherein the feedback signal comprises a rate control signal.

6. The FGS encoding system of claim 4, wherein a base layer rate controller determines an available number of bits.

7. The FGS encoding system of claim 1, wherein the U/V component is quantized to zero so that all available bits are assigned to the Y component.

8. The FGS encoding system of claim 1, wherein both a first quantization parameter associated with the Y component and a second quantization parameter associated with the U/V component can be varied based on an available number of bits.

9. A method of encoding a video signal using Fine Granular Scalability (FGS), comprising:
inputting a video signal into a base layer (BL) encoder;
performing a discrete cosine transform (DCT) operation to generate a DCT signal having a Y component and a UN component;
quantizing the Y component and U/V component separately such that more bits are assigned to the Y component than the UN component.

10. The method of claim 9, wherein the quantizing step includes utilizing a coarser quantization parameter for the U/V component than the Y component.

11. The method of claim 9, wherein the quantization parameter for the U/V component is fixed to a maximum value.

12. The method of claim 9, wherein the quantizing step includes:
determining an available number of bits; and
varying a quantization parameter for the Y component based on the available number of bits.

13. The method of claim 9, wherein the U/V component is quantized to zero so that all available bits are assigned to the Y component.

14. The method of claim 9, wherein both a first quantization parameter associated with the Y component and a second quantization parameter associated with the U/V component are varied based on an available number of bits.

15. A quantizer system for separately quantizing Y and U/V components in an encoder, comprising:
a first quantizer for quantizing a Y component with a first quantization parameter;
a second quantizer for separately quantizing a U/V component with a second quantization parameter; and
wherein the first quantization parameter is less than the second quantization parameter so that more bits are assigned to the Y component than the U/V component.

16. The quantizer system of claim 15, wherein the second quantization parameter is fixed to a maximum value.

17. The quantizer system of claim 15, wherein the U/V component is quantized to zero.

18. The quantizer system of claim 15, further comprising a feedback loop for providing a number of available bits.

19. The quantizer system of claim 18, wherein the number of available bits is provided by a base layer controller.

20. The quantizer system of claim 18, wherein the first and second quantization parameter is dynamically determined based up the number of available bits.
